(19) United States
(12) Patent Application Publication
(10) Pub. No.: US 2023/0347652 A1
(43) Pub. Date: Nov. 2, 2023

(54) CONTAINER HAVING SIDE WALL FORMED WITH RECESSED PORTION POSITIONED ABOVE LIQUID SUPPLY OPENING

(71) Applicant: BROTHER KOGYO KABUSHIKI KAISHA, Nagoya (JP)

(72) Inventors: Masahiro HAYASHI, Anjo (JP); Naoya OKAZAKI, Hashima (JP); Satoru OKI, Nagoya (JP); Yuma TANABE, Nagoya (JP); Yuji FUKUTA, Nagoya (JP)

(73) Assignee: BROTHER KOGYO KABUSHIKI KAISHA, Nagoya (JP)

(21) Appl. No.: 18/188,088

(22) Filed: Mar. 22, 2023

(30) Foreign Application Priority Data
Apr. 28, 2022 (JP) 2022-074713

(51) Int. Cl. B41J 2/175

(52) U.S. Cl. CPC B41J 2/17513

(57) ABSTRACT

A container includes a container body defining a storage chamber therein. The container body has a liquid supply opening that is open frontward and a communication opening that is open to the storage chamber. The container body includes: a liquid channel extending in a front-rear direction to connect the communication opening to the liquid supply opening; a front wall; a rear wall; a first side wall; a second side wall; an upper wall; and a lower wall. At least one of the first side wall and the second side wall has a recessed portion whose inner surface protrudes from an inner surface of the one of the first and second side walls. At least a part of the recessed portion is positioned above the liquid supply opening in an up-down direction. The inner surface of the recessed portion defines a part of the storage chamber.

### REFERENCE TO RELATED APPLICATIONS

This application claims priority from Japanese Patent Application No. 2022-074713 filed on Apr. 28, 2022. The entire content of the priority application is incorporated herein by reference.

### BACKGROUND ART

There has been known a printer including a recording head configured to eject, through nozzles, ink supplied from an ink cartridge. In such a printer, a new ink cartridge is newly attached to the printer when ink stored in an ink cartridge is consumed in the printer.

### DESCRIPTION

Various kinds of ink cartridges storing ink of different initial storage amounts are available in consideration of intended uses and prices. Producing such various kinds of ink cartridges having storage chambers of different internal volumes corresponding to the different initial storage amounts of ink may result in an increase in production cost and intricacy of material management. On the other end, it is also conceivable to produce a single kind of ink cartridge whose internal volume is constant and to differentiate amounts of ink to be stored in each storage chamber according to the respective initial storage amounts. However, in such ink cartridges of a single type, volumes of air layers in respective storage chambers may inevitably become different from one another. For example, as the volume of the air layer becomes larger in the storage chamber, ink bubbles are more likely to be generated in the storage chamber due to vibrations during transportation of the ink cartridge, which may degrade discharging performance of the ink from the ink cartridge. As a result, conceivably, the ink tends to remain in the storage chamber. Further, more air may be dissolved in the ink, which may lead to generation of bubbles in the head and ink channels of the printer.

On the other hand, conceivably, additional member may be provided in a storage chamber or a storage chamber may be partitioned by a partition wall in order to change the internal volume of the storage chamber. However, in such arrangements, ink may be deposited on the additional member or edges of the partition wall. Further, removal of ink remaining in the storage chamber becomes difficult to achieve for recycling of the ink cartridge.

In view of the foregoing, it is an object of the present disclosure to provide a container capable of providing a constant volume of an air layer in a storage chamber for various amounts of liquid stored in the storage chamber.

In order to attain the above and other object, the present disclosure provides a container attachable to an image-forming apparatus. The container includes a container body defining a storage chamber configured to store liquid therein. The container body has a liquid supply opening that is open frontward, and a communication opening that is open to the storage chamber. The container body includes: a liquid channel extending in a front-rear direction to connect the communication opening to the liquid supply opening; a front wall; a rear wall opposite the front wall in the front-rear direction; a first side wall connecting the front wall to the rear wall; a second side wall opposite the first side wall in a left-right direction crossing the front-rear direction; an upper wall connecting the front wall to the rear wall in the front-rear direction; and a lower wall opposite the upper wall in an up-down direction crossing the front-rear direction and the left-right direction. The first side wall has a first outer surface and a first inner surface. The second side wall has a second outer surface and a second inner surface. The upper wall also connects the first side wall to the second side wall in the left-right direction. At least one of the first side wall and the second side wall has a recessed portion. The recessed portion has: an outer surface that is recessed from the first outer surface or the second outer surface; and an inner surface protruding from the first inner surface or the second inner surface. At least a part of the recessed portion is positioned above the liquid supply opening in the up-down direction. The inner surface of the recessed portion defines a part of the storage chamber.

Since the capacity of the storage chamber is decreased by provision of the recessed portion, the volume of the air layer in the storage chamber can be maintained constant even if different amounts of liquid are stored in the storage chamber without a significant change in shape of the container body. Further, since at least a part of the recessed portion is positioned above the liquid supply opening, the liquid can reliably flow out of the storage chamber through the liquid supply opening, rather than staying in the part of the storage chamber defined by the inner surface of the recessed portion. Further, blow molding can be employed to produce the container body. Still further, the liquid is less likely to remain in the storage chamber, and the liquid remaining in the storage chamber can be easily removed therefrom for recycling of the container.

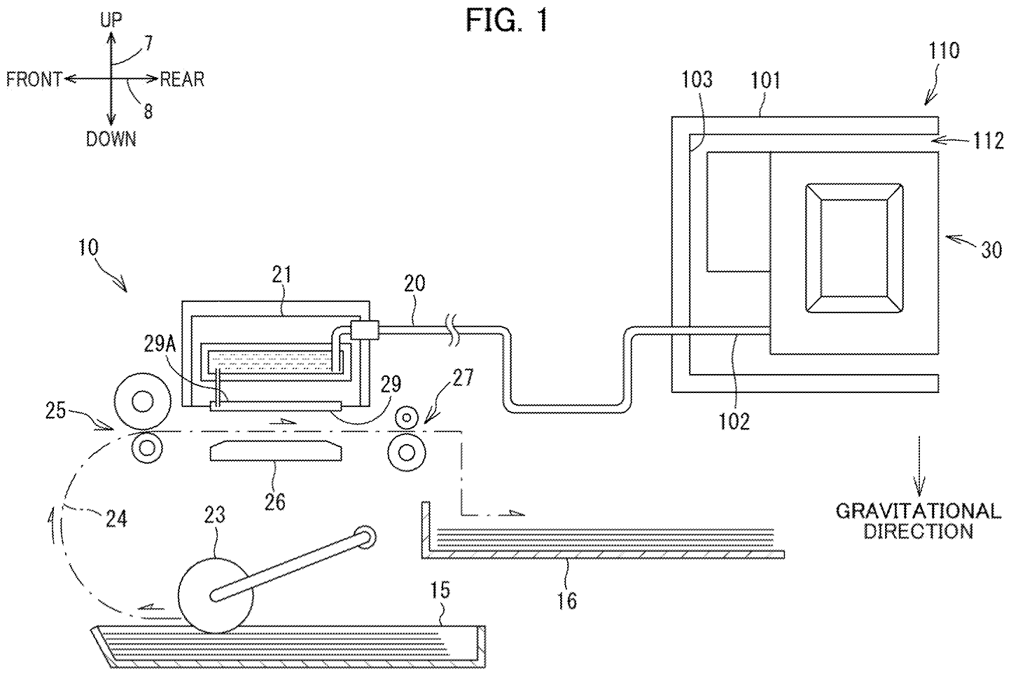

FIG. 1 is a schematic vertical cross-sectional view illustrating an internal structure of a printer 10.

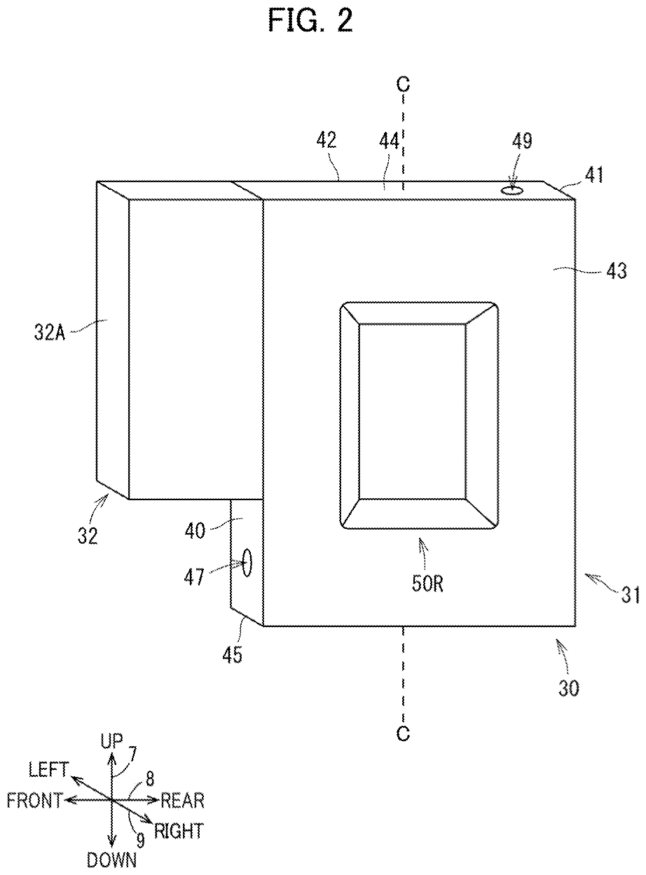

FIG. 2 is a perspective view of an ink cartridge 30 according to one embodiment.

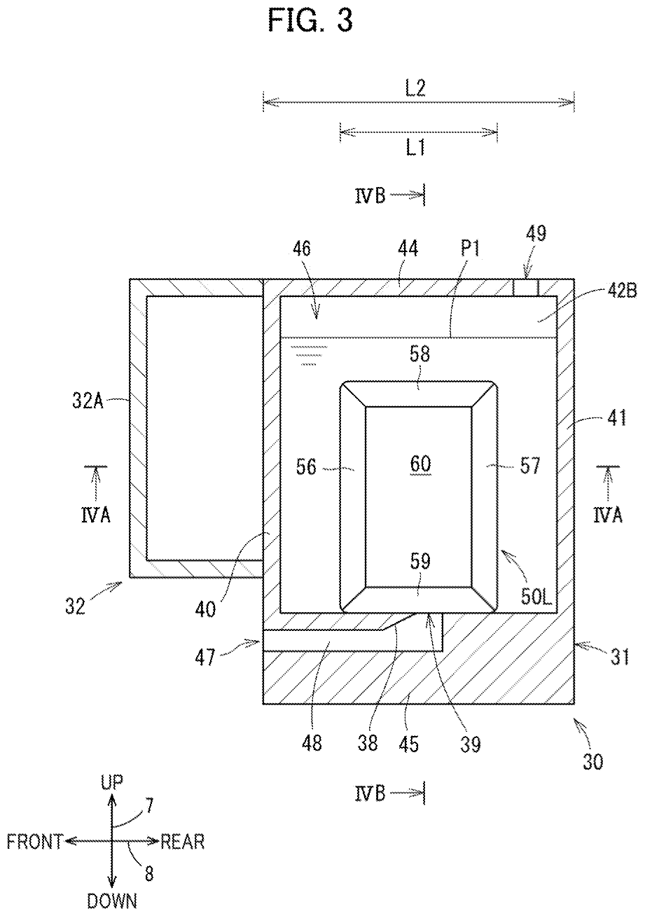

FIG. 3 is a vertical cross-sectional view of the ink cartridge 30 according to the one embodiment.

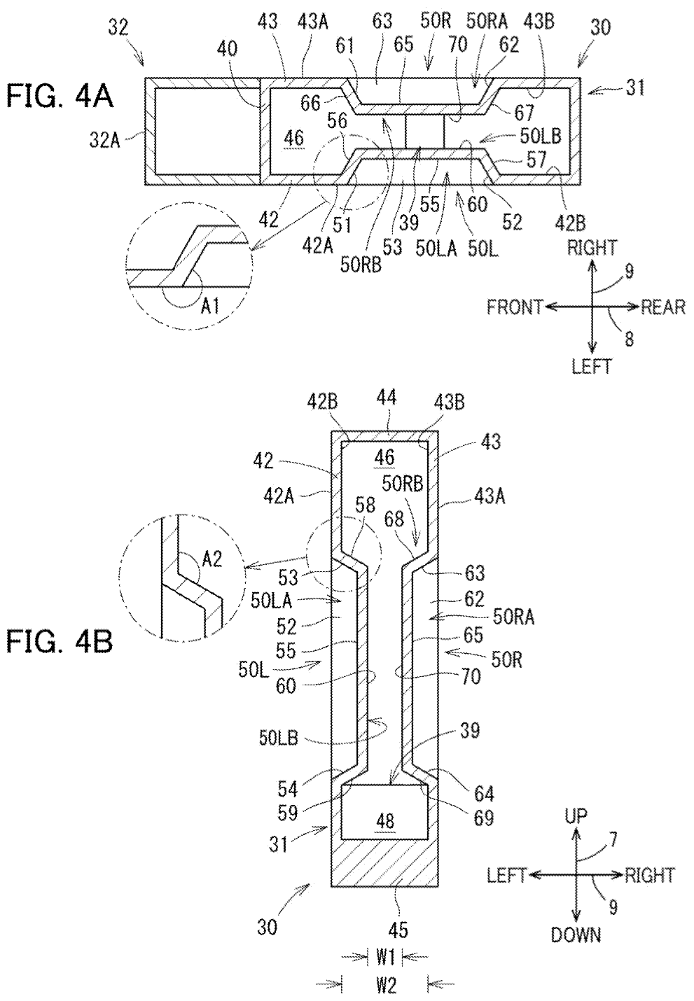

FIG. 4A is a cross-sectional view of the ink cartridge 30 taken along a line IVA-IVA in FIG. 3.

FIG. 4B is a cross-sectional view of the ink cartridge 30 taken along a line IVB-IVB in FIG. 3.

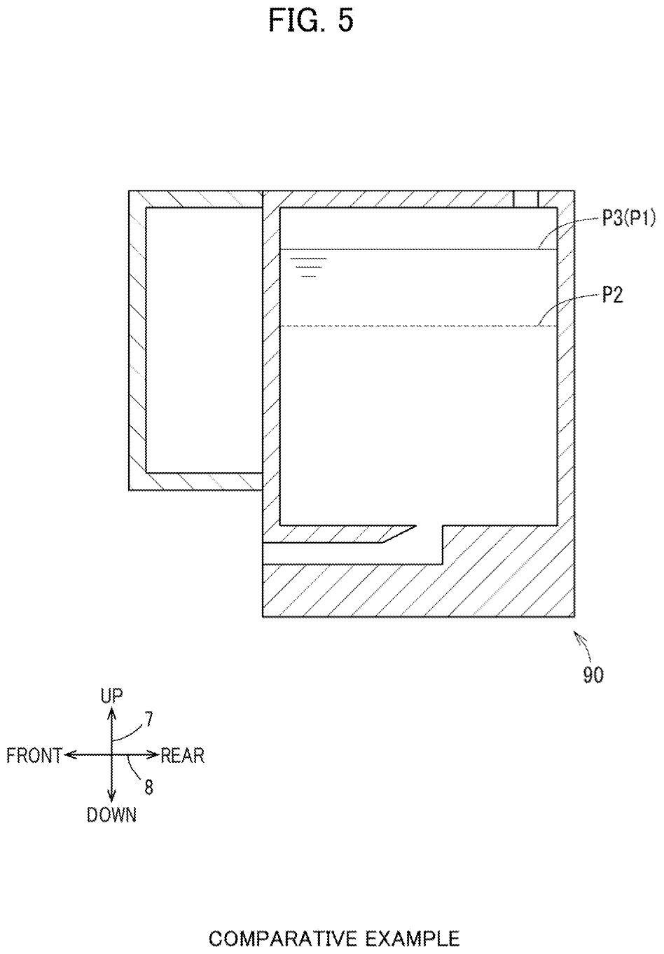

FIG. 5 is a vertical cross-sectional view of an ink cartridge 90 as a comparative example.

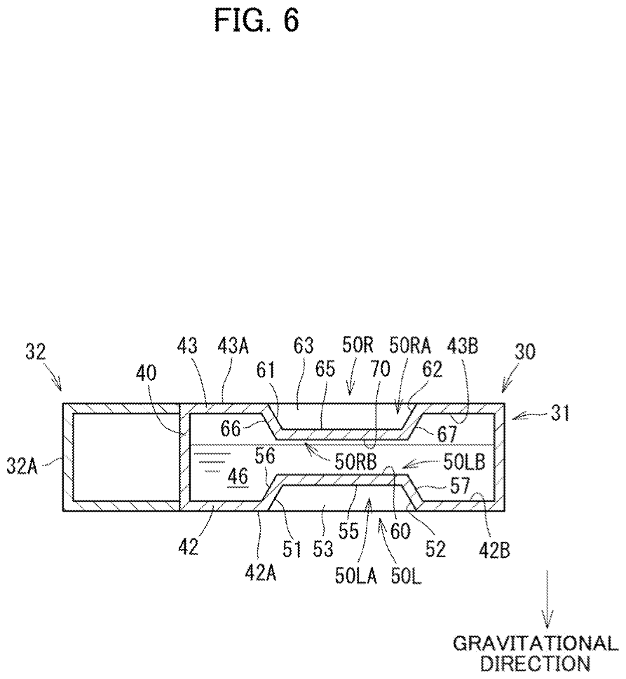

FIG. 6 is a cross-sectional view of the ink cartridge 30 taken along the line IVA-IVA in FIG. 3 in a state where the ink cartridge 30 is placed in a horizontal manner.

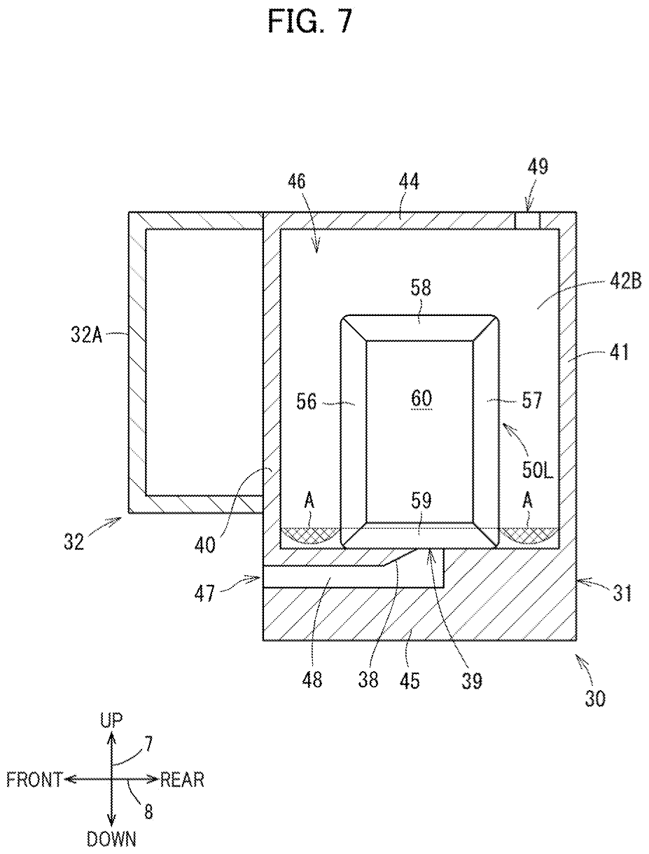

FIG. 7 is a vertical cross-sectional view of the ink cartridge 30 according to the one embodiment and particularly illustrating how air bubbles are aggregated in a storage chamber 46 of the ink cartridge 30.

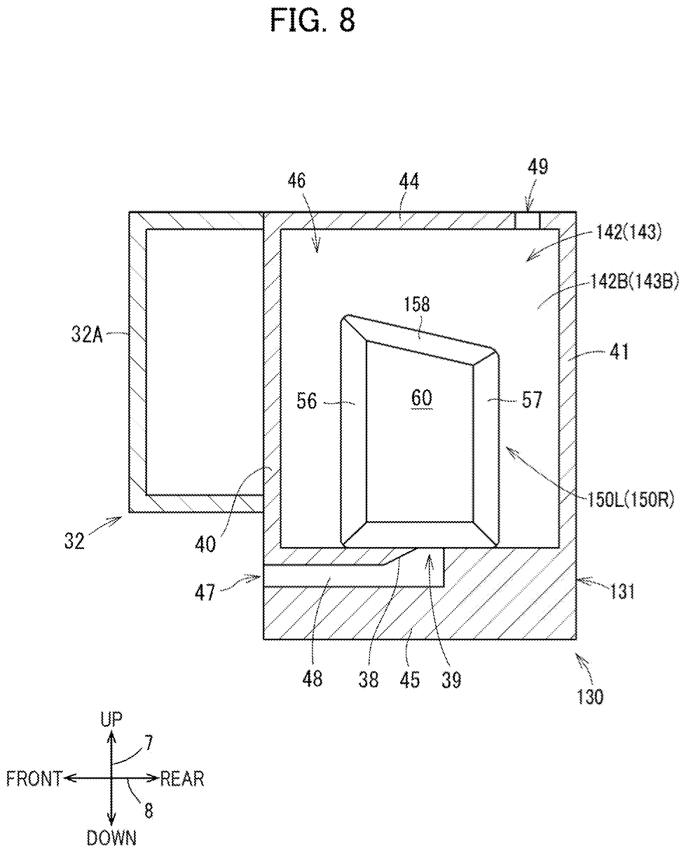

FIG. 8 is a vertical cross-sectional view of an ink cartridge 130 according to a first modification to the one embodiment.

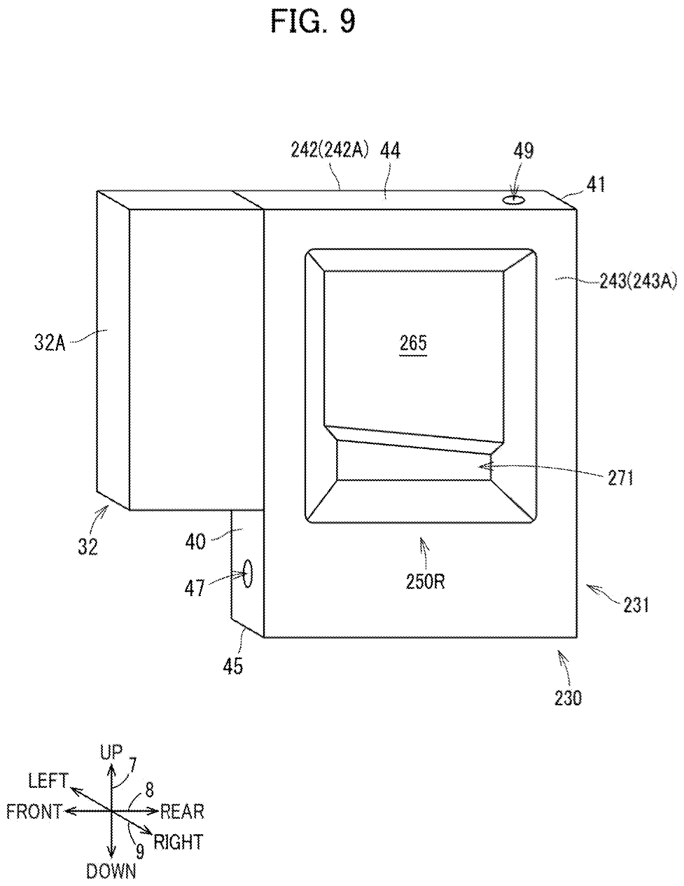

FIG. 9 is a perspective view of an ink cartridge 230 according to a second modification to the one embodiment.

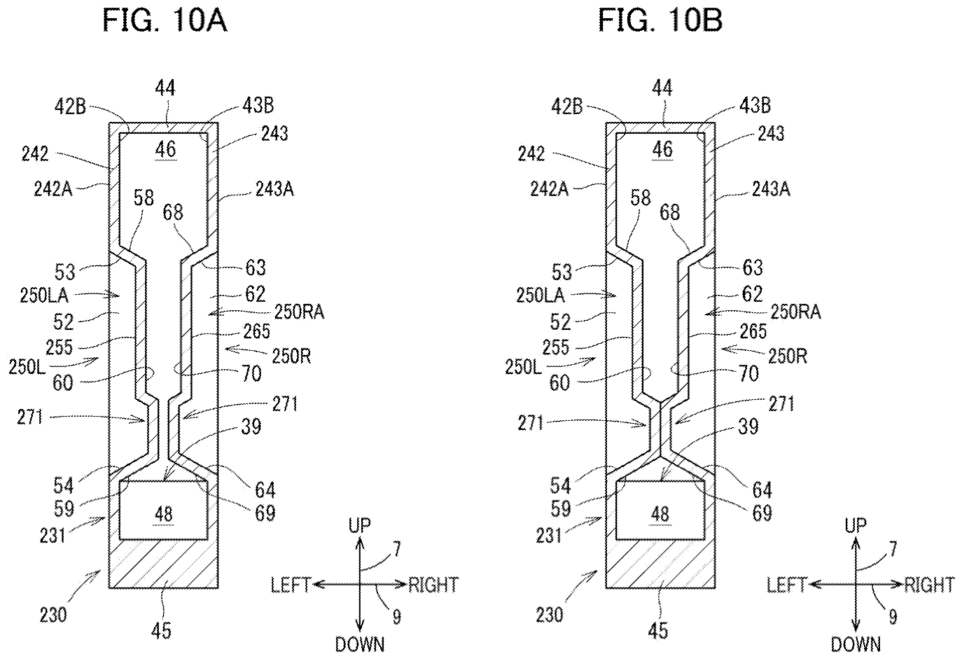

FIG. 10A is a cross-sectional view illustrating an internal structure of the ink cartridge 230 according to the second modification.

FIG. 10B is a cross-sectional view illustrating another internal structure of the ink cartridge 230 according to the second modification as a variation.

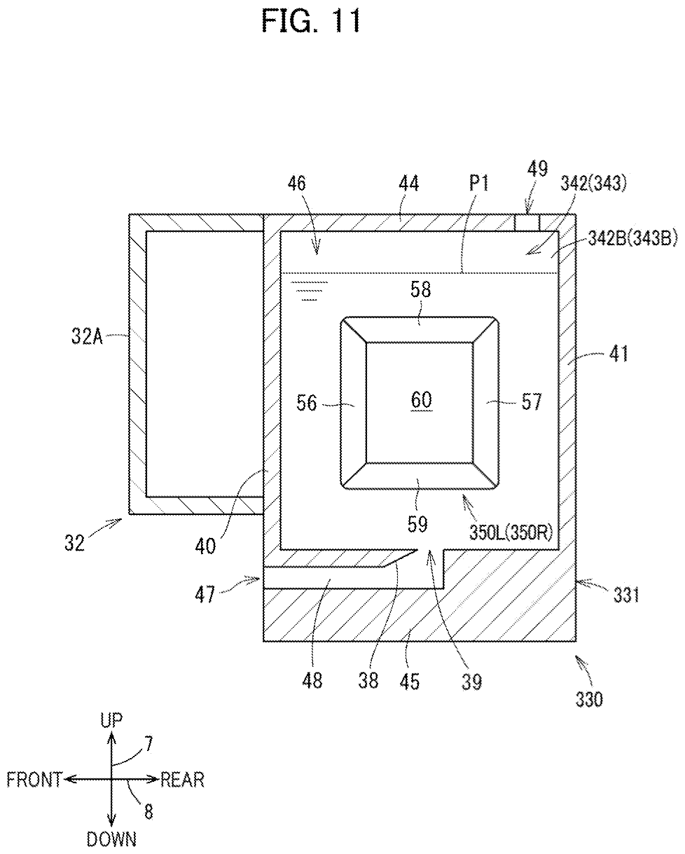

FIG. 11 is a vertical cross-sectional view of an ink cartridge 330 according to a third modification to the one embodiment.

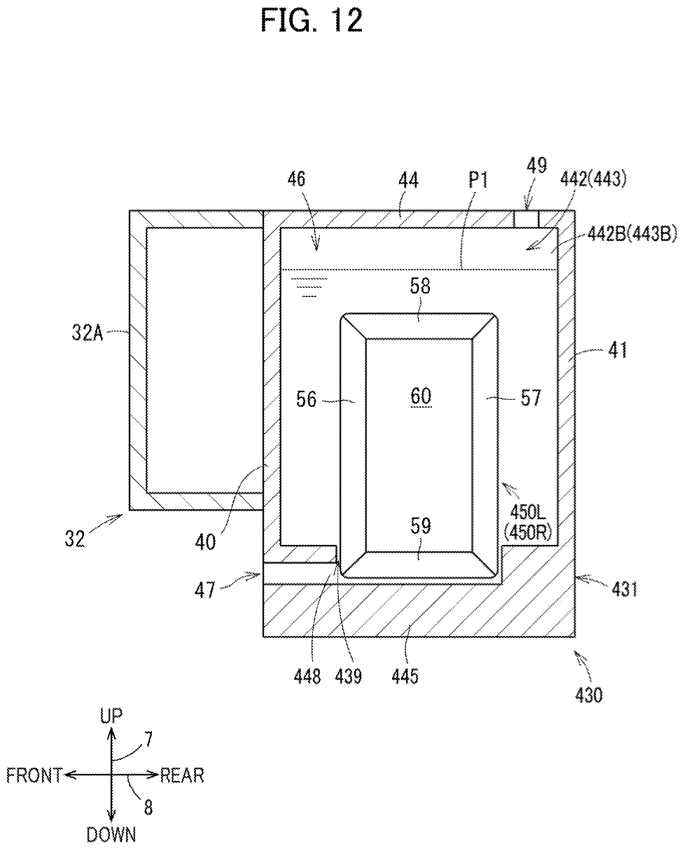

FIG. 12 is a vertical cross-sectional view of an ink cartridge 430 according to a fourth modification to the one embodiment.

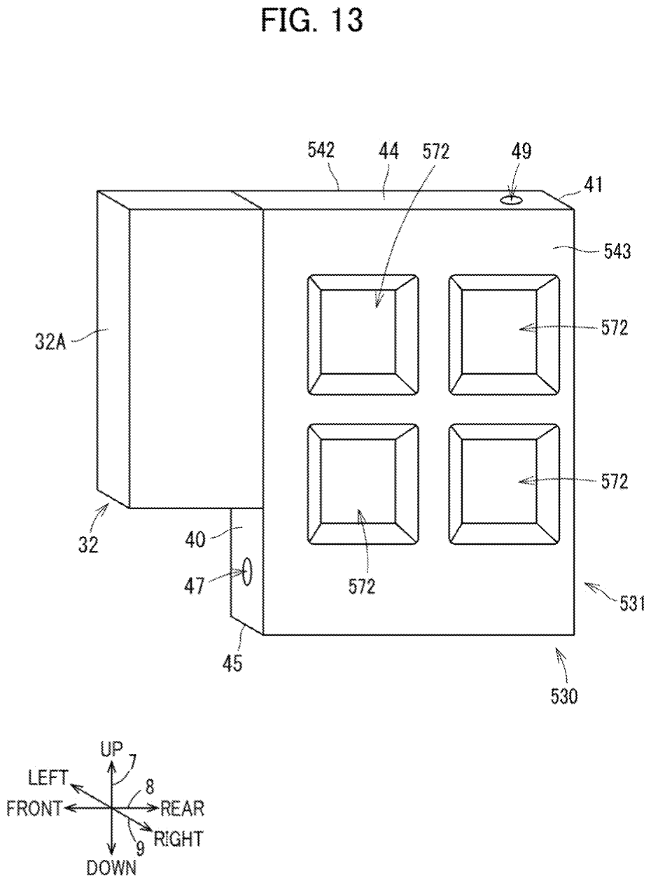

FIG. 13 is a perspective view of an ink cartridge 530 according to a fifth modification to the one embodiment.

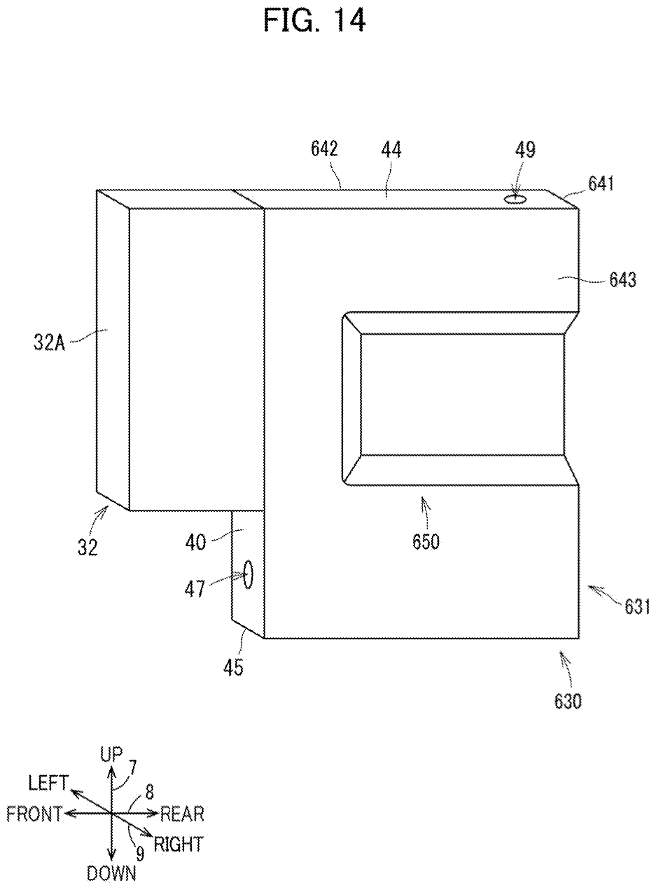

FIG. 14 is a perspective view of an ink cartridge 630 according to a sixth modification to the one embodiment.

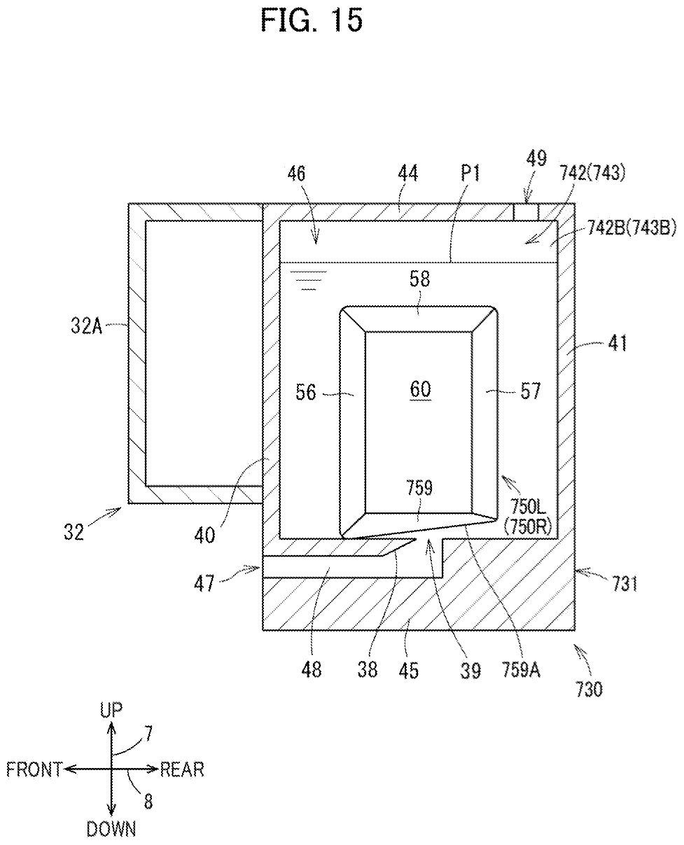

FIG. 15 is a vertical cross-sectional view of an ink cartridge 730 according to a seventh modification to the one embodiment.

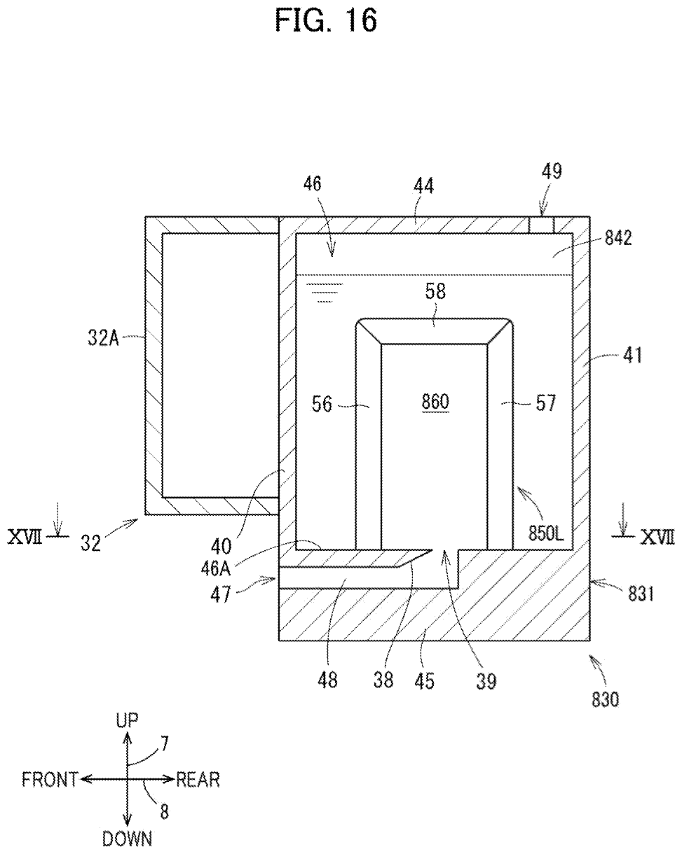

FIG. 16 is a vertical cross-sectional view of an ink cartridge 830 according to an eighth modification to the one embodiment.

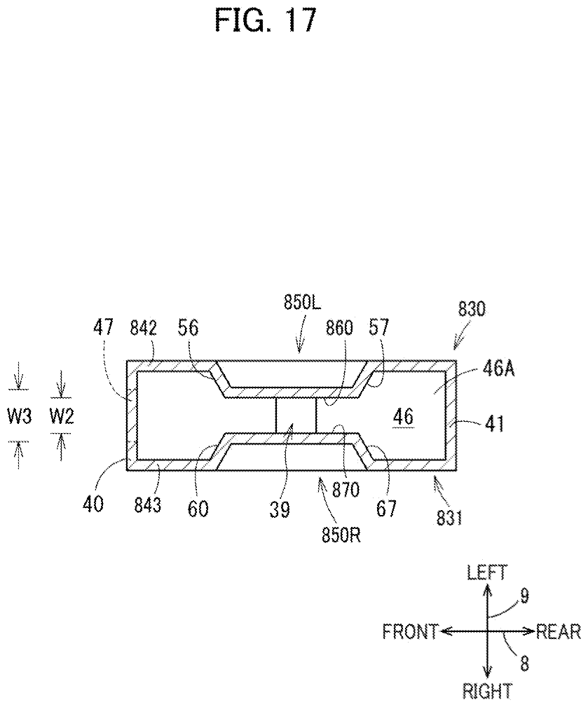

FIG. 17 is a horizontal cross-sectional view of the ink cartridge 830 taken along a line XVII-XVII in FIG. 16.

### EMBODIMENT

Hereinafter, an ink cartridge 30 according to one embodiment of the present disclosure will be described with reference to the accompanying drawings.

In the following description, the ink cartridge 30 is assumed to be inserted in and removed from a cartridge receiving portion 110 of a printer 10 in a horizontal direction (a direction perpendicular to the gravitational direction). Hence, a front-rear direction 8 and a left-right direction 9 with respect to the ink cartridge 30 will be referred to as being horizontal. Still however, the front-rear direction 8 need not be horizontal. Further, an up-down direction 7 will be defined as a vertical direction perpendicular to the front-rear direction 8. Also, the left-right direction 9 will be defined as a direction perpendicular to the up-down direction 7 and the front-rear direction 8.

Incidentally, a state where the ink cartridge 30 is accommodated in the cartridge receiving portion 110 and is actually used implies a state that the ink cartridge 30 has been inserted in the cartridge receiving portion 110 to be placed at an attached position therein. In the attached position of the ink cartridge 30, an ink needle 102 provided in the cartridge receiving portion 110 is inserted in an ink supply opening 47 of the ink cartridge 30 such that the ink needle 102 and the ink supply opening 47 are connected to each other. Further, in the following description, a posture of the ink cartridge 30 accommodated in the cartridge receiving portion 110 to be used thereby will be referred to as “operational posture” of the ink cartridge 30.

Further, in the following description, a frontward direction implies the direction of insertion of the ink cartridge 30 into the cartridge receiving portion 110, and a rearward direction implies the direction of removal of the ink cartridge 30 from the cartridge receiving portion 110 with respect to the front-rear direction 8. Further, throughout the description, “facing frontward” implies facing in a direction including a component of the frontward direction, and “facing rearward” implies facing in a direction including a component of the rearward direction. Further, “facing downward” implies facing in a direction including a component of the downward direction, and “facing upward” implies facing in a direction including a component of the upward direction. For example, “front surface faces frontward” implies not only that the front surface faces frontward, but also that the front surface faces in a direction slanting relative to the frontward direction.

<Outline of Printer 10>

As illustrated in FIG. 1, the printer 10 is an image-forming apparatus configured to form an image on a sheet by ejecting ink droplets thereon based on an inkjet recording scheme. The printer 10 may be an ink jet printer, for example. The printer 10 includes the cartridge receiving portion 110, a recording head 21, and an ink tube 20.

The cartridge receiving portion 110 is configured to receive the ink cartridge 30 according to the embodiment. The cartridge receiving portion 110 has one end face formed with an opening 112. The ink cartridge 30 can be inserted frontward into the cartridge receiving portion 110 through the opening 112, and the ink cartridge 30 can be pulled out rearward from the cartridge receiving portion 110 through the opening 112.

Incidentally, FIG. 1 depicts a state where the ink cartridge 30 has been completely accommodated in the cartridge receiving portion 110. That is, in FIG. 1, the ink cartridge 30 is in an attached state thereof. The ink cartridge 30 illustrated in FIG. 1 (in the attached state) is in the operational posture.

The ink cartridge 30 stores liquid therein, specifically, ink to be used in the printer 10. In the attached state of the ink cartridge 30 to the cartridge receiving portion 110, the ink cartridge 30 and the recording head 21 are connected to each other through the ink tube 20. The recording head 21 is configured to eject the ink supplied from the ink cartridge 30 through a plurality of nozzles 29. Specifically, a head control board (not illustrated) provided in the recoding head 21 is configured to selectively apply a driving voltage to a plurality of piezoelectric elements 29A each corresponding to each nozzle 29 to eject the ink through the selected nozzles 29. That is, the recording head 21 is configured to consume the ink stored in the ink cartridge 30 attached to the cartridge receiving portion 110.

The printer 10 also includes a sheet supply tray 15, a pick-up roller 23, a sheet conveying passage 24, a pair of conveying rollers 25, a platen 26, a pair of discharge rollers 27, and a sheet discharge tray 16. The pick-up roller 23 is configured to feed one sheet on the sheet supply tray 15 onto the sheet conveying passage 24. The sheet conveyed to the sheet conveying passage 24 then reaches the pair of conveying rollers 25. The pair of conveying rollers 25 is then configured to convey the sheet to the platen 26. The recording head 21 selectively ejects the ink onto the sheet while the sheet moves along the platen 26, to form an image on the sheet. The sheet having moved past the platen 26 is then conveyed to the pair of discharge rollers 27. The pair of discharge rollers 27 is configured to discharge the sheet onto the discharge tray 16 which is positioned most downstream in the conveying passage 24.

Cartridge Receiving Portion 110

As illustrated in FIG. 1, the cartridge receiving portion 110 includes a casing 101 and the ink needle 102. The ink cartridge 30 can be accommodated in the cartridge receiving portion 110.

As illustrated in FIG. 1, the casing 101 has a box-like shape constituting a housing of the cartridge receiving portion 110. The opening 112 can be exposed to a user interface surface of the printer 10 that a user faces when the user uses the printer 10.

The ink needle 102 is tubular in shape and is positioned at a lower end portion of an end wall 103 of the casing 101, the end wall 103 facing the opening 112 in the front-rear direction 8. The ink needle 102 is provided at the end wall 103 at a position in alignment with the ink supply opening 47 (see FIG. 3) of the ink cartridge 30 attached to the cartridge receiving portion 110. The ink needle 102 protrudes rearward from the end wall 103 of the casing 101 to have a protruding end (tip end) that is open rearward. The tip end of the ink needle 102 may be a flat tip or may be a pointed tip.

<Ink Cartridge 30>

The ink cartridge 30 is a container configured to store ink as liquid. As illustrated in FIG. 2, the ink cartridge 30 includes a container body 31 and a cover 32.

As illustrated in FIG. 2, the container body 31 has a generally flat rectangular parallelepiped shape whose dimension in the left-right direction 9 is smaller than dimensions thereof in the up-down direction 7 and front-rear direction 8.

The container body 31 includes: a front wall 40; a rear wall 41 opposite the front wall 40 in the front-rear direction 8; a left wall 42 connecting the front wall 40 to the rear wall 41; a right wall 43 opposite to the left wall 42 in the left-right direction 9; an upper wall 44 connecting the front wall 40 to the rear wall 41; and a lower wall 45 opposite to the upper wall 44 in the up-down direction 7. The front wall 40 has an outer surface facing frontward. The rear wall 41 has an outer surface facing rearward. The left wall 42 has an outer surface facing leftward. The right wall 43 has an outer surface facing rightward. The upper wall 44 has an outer surface facing upward. The lower wall 45 has an outer surface facing downward.

The front wall 40, the rear wall 41, the left wall 42, the right wall 43, the upper wall 44 and the lower wall 45 define in combination a storage chamber 46 which is an internal space of the container body 31. The front wall 40, the rear wall 41, the left wall 42, the right wall 43, the upper wall 44, and the lower wall 45 have a translucency to enable a user to visually recognize a level of the ink stored in the storage chamber 46. The container body 31 is, for example, a molded product made from synthetic resin.

The ink supply opening 47 is positioned at a lower end portion of the front wall 40 to allow the ink in the storage chamber 46 to flow out therefrom through the ink supply opening 47. In the present embodiment, the ink supply opening 47 is open to an outside of the container body 31. However, the ink supply opening 47 may be configured to be opened or closed by a value, for example. The ink supply opening 47 is open frontward. The ink supply opening 47 may have a rectangular shape or a circular shape, and need not be limited thereto.

As illustrated in FIG. 3, an ink channel 48 extends in the lower wall 45 rearward from the ink supply opening 47 inside the container body 31. The ink channel 48 extends in the front-rear direction 8 to be connected to a communication opening 39 formed at a lower end of the storage chamber 46. The ink channel 48 thus provides communication between the ink supply opening 47 and the communication opening 39. The communication opening 39 is positioned at a generally center in the front-rear direction 8 at the lower end of the storage chamber 46. The communication opening 39 is open upward. The communication opening 39 may have a rectangular shape or a circular shape, for example, and the shape of the communication opening 39 need not be limited thereto.

A sloped surface 38 is positioned frontward of the communication opening 39. The sloped surface 38 defines a part of an upper end of the ink channel 48. The sloped surface 38 faces diagonally downward and rearward. That is, the sloped surface 38 is sloped upward as extending toward the rear (toward the communication opening 39). With this structure, the ink stored in the storage chamber 46 can flow into the ink channel 48 through the communication opening 39 and then to the outside of the ink cartridge 30 through the ink supply opening 47. Further, air bubbles inside the ink channel 48 tend to move upward along the sloped surface 38 to go into the storage chamber 46 through the communication opening 39.

The upper wall 44 is formed with an air communication port 49 to provide communication between an upper end region (air layer) of the storage chamber 46 and an atmosphere. The storage chamber 46 can communicate with the atmosphere through the air communication port 49. Accordingly, due to the air flow through the air communication port 49, the air layer in the storage chamber 46 can become the atmospheric pressure. Incidentally, the air communication port 49 may be closed by a valve or a semipermeable membrane.

As illustrated in FIGS. 2 through 4B, the left wall 42 and the right wall 43 have a recessed portion 50L and a recessed portion 50R, respectively. The recessed portion 50L and the recessed portion 50R are symmetrical with each other in the left-right direction 9. The recessed portion 50L and the recessed portion 50R have a rectangular shape as viewed in the left-right direction 9. The recessed portion 50L and the recessed portion 50R are positioned each to overlap with a center C in the front-rear direction 8 between the front wall 40 and the rear wall 41. Referring to FIG. 3, each of the recessed portion 50L and the recessed portion 50R has a length L1 (maximum length) in the front-rear direction 8 equal to or greater than one half of a distance L2 (maximum distance) in the front-rear direction 8 between the front wall 40 and the rear wall 41, i.e., L1≥½×L2.

In the left wall 42 and the right wall 43, respective lower ends of the recessed portion 50L and the recessed portion 50R are at the same position (height) as the lower end of the storage chamber 46 in the up-down direction 7. With respect to the front-rear direction 8, the communication opening 39 is positioned between front and rear ends of each of the recessed portion 50L and the recessed portion 50R (see FIG. 4A). Further, the recessed portion 50L and the recessed portion 50R are respectively positioned above an upper end of the communication opening 39 and an upper end of the ink supply opening 47.

In the left wall 42 and the right wall 43, the recessed portions 50L, 50R are not open to any one of the front wall 40, the rear wall 41, the upper wall 44, and the lower wall 45. Here, “the recessed portions 50L, 50R are not open to any one of the front wall 40, the rear wall 41, the upper wall 44, and the lower wall 45” means that a recessed region provided by the recessed portion 50L on an outer surface 42A of the left wall 42 and a recessed region provided by the recessed portion 50R at an outer surface 43A of the right wall 43 are overlapped with any one of the front wall 40, the rear wall 41, the upper wall 44, and the lower wall 45 when viewed in the front-rear direction 8 or in the up-down direction 7 so that the recessed regions cannot be observed when viewed in the front-rear direction 8 or in the up-down direction 7.

As illustrated in FIGS. 2, 4A and 4B, the recessed portion 50L is recessed rightward from the outer surface 42A of the left wall 42. Accordingly, the outer surface 42A of the left wall 42 has a rectangular frame-like shape when viewed in the left-right direction 9. The recessed portion 50L has an outer surface 50LA facing outward, and an inner surface 50LB facing the storage chamber 46. The outer surface 50LA is recessed rightward from the outer surface 42A of the left wall 42. The inner surface 50LB protrudes rightward from an inner surface 42B of the left wall 42. The inner surface 50LB defines a part of the storage chamber 46 in combination with the inner surface 42B.

The recessed portion 50L provides a trapezoidal shape in cross-section. The outer surface 50LA includes a front inclined surface 51, a rear inclined surface 52, an upper inclined surface 53, a lower inclined surface 54, and an end surface 55. The end surface 55 has a rectangular shape as viewed in the left-right direction 9, and extends parallel to the outer surface 42A of the left wall 42. The front inclined surface 51 connects a front edge of the end surface 55 to the outer surface 42A, and a normal line of the front inclined surface 51 extends diagonally rearward and leftward. The rear inclined surface 52 connects a rear edge of the end surface 55 to the outer surface 42A, and a normal line of the rear inclined surface 52 extends diagonally frontward and leftward. The upper inclined surface 53 connects an upper edge of the end surface 55 to the outer surface 42A, and a normal line of the upper inclined surface 53 extends diagonally downward and leftward. The lower inclined surface 54 connects a lower edge of the end surface 55 to the outer surface 42A, and a normal line of the lower inclined surface 54 extends diagonally upward and leftward. Each of the front inclined surface 51, the rear inclined surface 52, the upper inclined surface 53, and the lower inclined surface 54 defines an outer angle A1 of less than 270 degrees with respect to the outer surface 42A.

The inner surface 50LB includes a front inclined surface 56, a rear inclined surface 57, an upper inclined surface 58, a lower inclined surface 59, and an end surface 60. The end surface 60 has a rectangular shape as viewed in the left-right direction 9, and extends parallel to the inner surface 42B of the left wall 42. The front inclined surface 56 connects a front edge of the end surface 60 to the inner surface 42B, and a normal line of the front inclined surface 56 extends diagonally frontward and rightward. The rear inclined surface 57 connects a rear edge of the end surface 60 to the inner surface 42B, and a normal line of the rear inclined surface 57 extends diagonally rearward and rightward. The upper inclined surface 58 connects an upper edge of the end surface 60 to the inner surface 42B, and a normal line of the upper inclined surface 58 extends diagonally upward and rightward. The lower inclined surface 59 connects a lower edge of the end surface 60 to the inner surface 42B, and a normal line of the lower inclined surface 59 extends diagonally downward and rightward. Each of the front inclined surface 56, the rear inclined surface 57, the upper inclined surface 58, and the lower inclined surface 59 defines an inner angle A2 of greater than 90 degrees with respect to the inner surface 42B.

As illustrated in FIGS. 2, 4A and 4B, the recessed portion 50R is recessed leftward from the outer surface 43A of the right wall 43. The outer surface 43A of the right wall 43 has a rectangular frame-like shape when viewed in the left-right direction 9. The recessed portion 50R has an outer surface 50RA facing outward and an inner surface SORB facing the storage chamber 46. The outer surface 50RA is recessed leftward from the outer surface 43A of the right wall 43. The inner surface SORB protrudes leftward from an inner surface 43B of the right wall 43. The inner surface SORB defines a part of the storage chamber 46 in combination with the inner surface 43B.

The recessed portion 50R has a trapezoidal shape in cross-section. The outer surface 50RA includes a front inclined surface 61, a rear inclined surface 62, an upper inclined surface 63, a lower inclined surface 64, and an end surface 65. The end surface 65 has a rectangular shape as viewed in the left-right direction 9, and extends parallel to the outer surface 43A of the right wall 43. The front inclined surface 61 connects a front edge of the end surface 65 to the outer surface 43A, and a normal line of the front inclined surface 61 extends diagonally rearward and rightward. The rear inclined surface 62 connects a rear edge of the end surface 65 to the outer surface 43A, and a normal line of the rear inclined surface 62 extends diagonally frontward and rightward. The upper inclined surface 63 connects an upper edge of the end surface 65 to the outer surface 43A, and a normal line of the upper inclined surface 63 extends diagonally downward and rightward. The lower inclined surface 64 connects a lower edge of the end surface 65 to the outer surface 43A, and a normal line of the lower inclined surface 64 extends diagonally upward and rightward. Each of the front inclined surface 61, the rear inclined surface 62, the upper inclined surface 63, and the lower inclined surface 64 defines an outer angle equal to the outer angle A1 of less than 270 degrees with respect to the outer surface 43A.

The inner surface SORB includes a front inclined surface 66, a rear inclined surface 67, an upper inclined surface 68, a lower inclined surface 69, and an end surface 70. The end surface 70 has a rectangular shape as viewed in the left-right direction 9, and extends parallel to the inner surface 43B of the right wall 43. The front inclined surface 66 connects a front edge of the end surface 70 to the inner surface 43B, and a normal line of the front inclined surface 66 extends diagonally frontward and leftward. The rear inclined surface 67 connects a rear edge of the end surface 70 to the inner surface 43B, and a normal line of the rear inclined surface 67 extends diagonally rearward and leftward. The upper inclined surface 68 connects an upper edge of the end surface 70 to the inner surface 43B, and a normal line of the upper inclined surface 68 extends diagonally upward and leftward. The lower inclined surface 69 connects a lower edge of the end surface 70 to the inner surface 43B, and a normal line of the lower inclined surface 69 extends diagonally downward and leftward. Each of the front inclined surface 66, the rear inclined surface 67, the upper inclined surface 68, and the lower inclined surface 69 defines an inner angle equal to the inner angle A2 of greater than 90 degrees with respect to the inner surface 43B.

The inner surface 50LB of the recessed portion 50L of the left wall 42 faces the inner surface SORB of the recessed portion 50R of the right wall 43 in the left-right direction 9. The inner surface 50LB and the inner surface SORB respectively define a part of the storage chamber 46. That is, ink can be stored between the inner surface 50LB and the inner surface SORB.

The communication opening 39 is open to the storage chamber 46, particularly to a space defined between the inner surface 50LB and the inner surface SORB in the left-right direction 9 (se FIG. 4A). The communication opening 39 has left and right edges connected to the inner surface 50LB and the inner surface SORB, respectively. As illustrated in FIG. 4B, a width W1 in the left-right direction 9 defined between the end surface 60 of the inner surface 50LB and the end surface 70 of the inner surface SORB is smaller than a width W2 in the left-right direction 9 defined between the right and left edges of the communication opening 39 (W1<W2). Incidentally, the width W2 of the communication opening 39 may be equal to or greater than a width of the ink supply opening 47 in the left-right direction 9.

The cover 32 has a rectangular parallelepiped shape whose size is smaller than the size of the container body 31. The cover 23 has a box-like configuration which is open rearward. The cover 32 is attached to the container body 31 such that the cover 32 covers an upper portion of the front wall 40 of the container body 31, the upper portion being above the ink supply opening 47. The cover 32 has a front end 32A positioned frontward of the ink supply opening 47 in the front-rear direction 8.

The storage chamber 46 of the container body 31 is configured to store ink therein. As illustrated in FIG. 3, in an initial state (unused state) of the ink cartridge 30, the ink in the storage chamber 46 provides an ink level P1 which is higher than the respective upper edges of the recessed portions 50L, 50R. Specifically, the storage chamber 46 of the ink cartridge 30 having the recessed portions 50L, 50R has a capacity smaller than a capacity of a storage chamber of an ink cartridge without the recessed portions 50L, 50R.

FIG. 5 illustrates an ink cartridge 90 that does not have the recessed portions 50L and 50R as a comparative example. In this comparative example, in the initial state of the ink cartridge 90, the ink cartridge 90 is assumed to store, in a storage chamber thereof, such an amount of ink that is equal to the initial amount of ink stored in the ink cartridge 30 of FIG. 3. In the initial state of the ink cartridge 90, the ink in the storage chamber of the ink cartridge 90 provides an ink level P2 (indicated by a broken line in FIG. 5) that is lower than the ink level P1 indicative of the initial amount of ink stored in the ink cartridge 30 (see FIG. 3). This is because the storage chamber of the ink cartridge 90 has a larger capacity than the storage chamber 46 of the ink cartridge 30 due to the non-provision of the recessed portions 50L, 50R in the ink cartridge 90. Reversely, the ink cartridge 90 without the recessed portions 50L and 50R provides an ink level P3, which is equal to the ink level P1 of the ink cartridge 30, in a case where the ink cartridge 90 stores an initial amount of ink that is greater than the initial amount of ink stored in the ink cartridge 30.

As the ink stored in the storage chamber 46 of the ink cartridge 30 is consumed by the recording head 21, the level of ink (liquid surface of the ink) in the storage chamber 46 is gradually lowered to a position lower than the upper inclined surface 58 of the recessed portion 50L and the upper inclined surface 68 of the recessed portion 50R. At this time, the ink flows downward along the upper inclined surfaces 58 and 68.

Further, as illustrated in FIG. 6, assuming that the ink cartridge 30 is placed in a horizontal posture so that the left wall 42 and the right wall 43 of the container body 31 are aligned with each other in the up-down direction 7, the recessed portion 50L and the recessed portion 50R are also aligned with each other in the up-down direction 7. In this horizontal posture, at least a part of the recessed portion 50L or 50R is positioned higher than the liquid surface of the ink stored in the storage chamber 46. When the posture of the ink cartridge 30 is changed from the horizontal posture to an upright posture (the posture in the attached state illustrated in FIG. 2), the ink flows downward through the spaces frontward and rearward of the recessed portions 50L, 50R, as well as through the space between the recessed portions 50L and 50R, within the storage chamber 46. Such flow of ink results in agitation of the ink in the storage chamber 46.

Further, as illustrated in FIG. 7, now assume that air bubbles A are generated in the storage chamber 46 when the level of the ink stored in the storage chamber 46 is decreased down to the space between the recessed portions 50L and 50R due to the consumption of the ink by the recording head 21. At this time, since the distance in the left-right direction 9 between the recessed portions 50L and 50R (for example, the width W1) is smaller than a distance in the left-right direction 9 of a part of the storage chamber 46 other than the recessed portions 50L, 50R (for example, the width W2), the air bubbles A tend to be aggregated in a wider space, i.e., in the spaces forward and rearward of the recessed portions 50L, 50R. As a result, the air bubbles A are less likely to be aggregated in a region immediately above the communication opening 39, as illustrated in FIG. 7. Hence, the air bubbles A are less likely to move into the ink channel 48 through the communication opening 39.

### Technical Advantages of the Embodiment

According to the ink cartridge 30 of the embodiment, the capacity of the storage chamber 46 becomes smaller due to the provision of the recessed portions 50L and 50R, compared to the comparative ink cartridge 90 without the recessed portions 50L, 50R. With this configuration, the air layer in the storage chamber 46 can have a constant volume without significant modifications to the outer shape of the container body 31. Further, even if a variety of amounts of ink is to be stored in a plurality of the ink cartridges 30, the volume of the air layer in the storage chamber 46 of each ink cartridge 30 can be made constant by simply changing the size and/or the number of the recessed portions 50L, 50R provided at each container body 31.

Further, since at least a part of the recessed portions 50L and 50R is positioned higher than the ink supply opening 47, the ink stored in the space between the end surface 60 of the recessed portion 50L and the end surface 70 of the recessed portion 50R can reliably flow out of the ink supply opening 47 with little deposition of the ink on the end surfaces 60, 70.

Further, in a case where blow molding is employed for molding the container body 31, blow pressure is applied to the internal space between the recessed portions 50L and 50R inside the container body 31, which facilitates forming the container body 31 with a constant thickness. Further, since the ink is stored between the recessed portions 50L and 50R, the ink is less likely to remain in the storage chamber 46, and residual ink that may remain in the storage chamber 46, if any, can be easily removed by washing away with water during a recycling process of the ink cartridge 30.

Further, the level of ink stored in the storage chamber 46 can be visually observed from the outside of the container body 31, since the left wall 42 and the right wall 43 of the container body 31 are light transmissive.

Further, since the inner surface 50LB of the recessed portion 50L and the inner surface 50LRB of the recessed portion 50R face each other, the capacity of the storage chamber 46 can be easily adjusted and the container body 31 can be well balanced in terms of its weight.

Further, the ink is less likely to remain on the front inclined surfaces 56, 66, the rear inclined surfaces 57, 67, the upper inclined surfaces 58, 68, and the lower inclined surfaces 59, 69, since these surfaces respectively form the inner angle A2 of greater than 90 degrees relative to the corresponding inner surfaces 42B, 43B of the left and right walls 42, 43 of the container body 31.

In the above-described embodiment, the recessed portion 50L of the left wall 42 and the recessed portion 50R of the right wall 43 are overlapped with the center C between the front wall 40 and the rear wall 41 in the front-rear direction 8. Further, the length L1 of the recessed portion 50L (or the recessed portion 50R) is equal to or greater than one half of the distance L2 of the corresponding left wall 42 (or the right wall 43). With this configuration, each of the recessed portions 50L and 50R can occupy a larger part of the corresponding left wall 42 or the right wall 43, and the capacity of the storage chamber 46 can be easily adjusted even more easily.

Further, the container body 31 has a high rigidity, since the recessed portions 50L, 50R are not open to any one of the front wall 40, the rear wall 41, the upper wall 44, and the lower wall 45.

Further, the sloped surface 38 defining a part of the ink channel 48 can facilitate movement of air bubbles inside in the ink channel 48 into storage chamber 46 through the communication opening 39.

### MODIFICATIONS

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described invention are provided below:

Hereinafter, various modifications to the above-described embodiment will be described with reference to accompanying drawings wherein like parts and components are designated by the same reference numerals as those of the above-described embodiment.

### First Modification

FIG. 8 illustrates an ink cartridge 130 according to a first modification to the embodiment. According to the above-described embodiment, the upper inclined surface 58 of the recessed portion 50L and the upper inclined surface 68 of the recessed portion 50R extend in the front-rear direction 8. In contrast, in a container body 131 of the ink cartridge 130 according to the first modification, a recessed portion 150L on a left wall 142 (inner surface 142B) has an upper inclined surface 158 extending be inclined relative to the front-rear direction 8. With this structure, ink can easily flow down along the upper inclined surface 158 due to the gravity. Incidentally, the container body 131 may also have a recessed portion 150R on a right wall 143 (inner surface 143B). Like the recessed portion 150L, the recessed portion 150R may have an upper inclined surface that extends to be inclined relative to the front-rear direction 8.

### Second Modification

FIG. 9 illustrates an ink cartridge 230 according to a second modification to the embodiment. According to the above-described embodiment, the recessed portions 50L, 50R have the end surfaces 55, 65 each of which is configured of a single flat surface. In contrast, in a container body 231 of the ink cartridge 230 according to the second modification, a recessed portion 250R on a right wall 243 (outer surface 243A) has an end surface 265 formed with a sub-recessed portion 271. A corresponding sub-recessed portion 271 is also provided in an end surface 255 of a recessed portion 250L on a left wall 242 (outer surface 242A) of the container body 231, as illustrated in FIGS. 10A and 10B. That is, each of the recessed portions 250R, 250L (outer surfaces 250RA, 250LA thereof) may have a two-stepped structure that is recessed inward from each outer surface 243A, 242A. Still alternatively, not less than three sub-recessed portions 271 may be provided in each end face 265, 255 of the outer surfaces 250RA, 250LA to constitute a multi-stepped structure that is recessed inward from each outer surface 243A, 242A.

In connection with the second modification where the sub-recessed portions 271 are provided, inner surfaces of the two opposing sub-recessed portions 271 may face each other in the left-right direction 9 with a space defined therebetween as illustrated in FIG. 10A, so that the inner surfaces of the two opposing sub-recessed portions 271 define a part of the storage chamber 46. Alternatively, as illustrated in FIG. 10B, the inner surfaces of the two-opposing sub-recessed portions 271 may be in contact with each other without a space therebetween, so that the inner surfaces do not define a part of the storage chamber 46.

### Third Modification

FIG. 11 illustrates an ink cartridge 330 according to a third modification to the embodiment. According to the above-described embodiment, the lower edges of the recessed portions 50L, 50R on the left wall 42 and right wall 43 are at the same position as the lower end of the storage chamber 46 in the up-down direction 7. In contrast, the ink cartridge 330 according to the third modification has recessed portions 350L, 350R whose lower edges are positioned above the lower end of the storage chamber 46 so as to be spaced away therefrom in the up-down direction 7 in a container body 331. That is, inner surfaces of the recessed portions 350L, 350R on inner surfaces 342B, 343B of left and right walls 342, 343 of the container body 331 are spaced away from the communication opening 39 in the up-down direction 7. Accordingly, the inner surfaces of the respective recessed portions 350L, 350R are not continuous with the communication opening 39.

### Fourth Modification

FIG. 12 illustrates an ink cartridge 430 according to a fourth modification to the embodiment. According to the fourth modification, the ink cartridge 430 has recessed portions 450L, 450R whose lower edges are positioned below the lower end of the storage chamber 46 in the up-down direction 7 in a container body 431. That is, the lower edges of the recessed portions 450L and 450R on inner surfaces 442B, 443B of left and right walls 442, 443 of the container body 431 are positioned below a communication opening 439 formed in the lower end of the storage chamber 46.

Further, inner surfaces of the recessed portions 450L and 450R constitute a part of an ink channel 448 formed in a lower wall 445 of the container body 431. To this end, the communication opening 439 may have a dimension greater than a dimension of the recessed portions 450L and 450R in the front-rear direction 8. Each of the recessed portions 450L and 450R has a portion positioned above the ink supply opening 47 in the up-down direction 7 (meaning that a remaining portion is positioned in alignment with the ink supply opening 47 in the up-down direction 7). Further, the ink channel 448 may not have the sloped surface 38, irrespective of the position and shape of the recessed portions 450L, 450R.

### Fifth Modification

FIG. 13 illustrates an ink cartridge 530 according to a fifth modification to the embodiment. According to the present embodiment, the left wall 42 has a single recessed portion 50L, and the right wall 43 has a single recessed portion 50R. In contrast, in the ink cartridge 530 of the fifth modification, a plurality of (four) recessed portions 572 is formed in a right wall 543 of a container body 531. Similarly, a plurality of (four) recessed portions 572 may also be formed in a left wall 542 of the container body 531. If this is the case, the recessed portions 572 on the right wall 543 and the recessed portions 572 on the left wall 542 may be positioned symmetrically or asymmetrically with each other with respect to the left-right direction 9.

### Sixth Modification

FIG. 14 illustrates an ink cartridge 630 according to a sixth modification to the embodiment. In the above-described embodiment, the recessed portions 50L, 50R are provided in the left and right walls 42, 43, respectively. In contrast, in the ink cartridge 630 according to the sixth modification, a single recessed portion 650 may be formed only in one of a left wall 642 and a right wall 643 of a container body 631.

Further, the recessed portion 650 on the right wall 643 is open to a rear wall 641 of the container body 631 in the sixth embodiment. However, the recessed portion 650 may be open to the front wall 40, or the upper wall 44, or the lower wall 45 of the container body 631. Likewise, in a case where the recessed portion 650 is formed only in the left wall 642, the recessed portion 650 may also be open to any one of the front wall 40, or the rear wall 641, or the upper wall 44, or the lower wall 45 of the container body 631.

### Seventh Modification

FIG. 15 illustrates an ink cartridge 730 according to a seventh modification to the embodiment. According to the above-described embodiment, the lower edges of the recessed portions 50L, 50R extend in the front-rear direction 8 which is coincident with the horizontal direction. However, the recessed portions 50L, 50R may extend in a direction inclined with respect to the front-rear direction 8.

Specifically, referring to FIG. 15, the ink cartridge 730 according to the seventh modification has recessed portion 750L, 750R whose lower edges are slanted relative to the front-rear direction 8 on inner surfaces 742B, 743B of left and right walls 742, 743 of a container body 731. In the ink cartridge 730, a lower inclined surface 759 of the recessed portion 750L defines a ridge 759A (lower end of the recessed portion 750L) relative to the inner surface 742B of the left wall 742. The ridge 759A is inclined relative to the front-rear direction 8 such that the ridge 759A extends diagonally upward as extending rearward away from the communication opening 39 in the front-rear direction 8. The recessed portion 750R on the right wall 743 (inner surface 743B) of the container body 731 has a similar configuration to the recessed portion 750L. With this structure, air bubbles are encouraged to move, along the inclined ridge 759A, upward and rearward away from the communication opening 39. Accordingly, the air bubbles are less likely to be introduced into the ink channel 48.

As a further modification, the ridge 759A may be inclined relative to the front-rear direction 8 so as to extend diagonally upward toward the front away from the communication opening 39 in the front-rear direction 8. Still alternatively, the ridge 759A may have a V-shape that is open upward in a side view. That is, the ridge 759A may have front and rear sides sloping diagonally upward toward the front and the rear, respectively, as extending away from the communication opening 39 in the front-rear direction 8.

### Eighth Modification

FIGS. 16 and 17 illustrates an ink cartridge 830 according to an eighth modification to the embodiment. According to the above-described embodiment, each of the recessed portions 50L, 50R includes inclined surfaces at upper, lower, front and rear ends of the end surface 60, 70. However, inclined surfaces of the recessed portions 50L, 50R may be provided arbitrary. As an example, as illustrated in FIGS. 16 and 17, the ink cartridge 830 according to the eighth modification includes a recessed portion 850L that does not have the lower inclined surface 59. In this case, an end surface 860 of the recessed portion 850L on a left wall 842 is connected to a lower end surface 46A of the storage chamber 46 in a container body 831. Similarly, a recessed portion 850R on a right wall 843 of the container body 831 does not have the lower inclined surface 69, and an end surface 870 of the recessed portion 850R is connected to the lower end surface 46A of the storage chamber 46. The communication opening 39 is positioned between the end surfaces 860 and 870 in the left-right direction 9. In the present modification, the width W2 of the communication opening 39 is smaller than a width W3 of the ink supply opening 47 in the left-right direction 9 (W2<W3).

<Other Variations>

According to the above-described embodiment, the recessed portions 50L, 50R have a rectangular outer shape. However, the recessed portions 50L 50R may have a polygonal outer shape other than the rectangular outer shape. Still further, the recessed portions 50L, 50R may have a circular shape, an elliptical shape, and a star-like shape, and the like.

In the above-described embodiment, ink is stored in the container body 31 as an example of liquid (as a recording material). However, the container body 31 may store liquid other than ink, such as pretreatment liquid configured to be ejected onto a sheet prior to printing with ink.

[Remarks]

The ink cartridges 30, 130, 230, 330, 430, 530, 630, 730, 830 are examples of a container. The container bodies 31, 131, 231, 331, 431, 531, 631, 731, 831 are examples of a container body. The storage chamber 46 is an example of a storage chamber. The ink supply opening 47 is an example of a liquid supply opening. The ink channels 48, 448 are examples of a liquid channel. The front wall 40 is an example of a front wall. The rear wall 41 is an example of a rear wall. The left walls 42, 142, 242, 342, 442, 542, 642, 742, 842 are examples of a first side wall. The right walls 43, 143, 243, 343, 443, 543, 643, 743, 843 are examples of a second side wall. The upper wall 44 is an example of an upper wall. The lower walls 45, 445 are examples of a lower wall. The recessed portions 50L, 50R, 150L, 150R, 250L, 250R, 350L, 350R, 450L, 450R, 650, 750L, 750R, 850L, 850R are examples of a recessed portion. The outer surfaces 50LA, 50RA, 250LA, 250RA are examples of an outer surface of the recessed portion. The inner surfaces 50LB, SORB are examples of an inner surface of the recessed portion. The inclined surfaces 56, 57, 58, 59, 66, 67, 68, 69, 759 are examples of a crossing surface. The communication openings 39, 439 are examples of a communication opening. The upper inclined surface 158 is an example of an upper inclined surface. The sub-recessed portion 571 is an example of a sub-recessed portion. The ridge 759A is an example of a ridge. The sloped surface 38 is an example of a sloped surface of the liquid channel. The width W2 is an example of a dimension of the communication opening in the left-right direction. The width W3 is an example of a dimension of the liquid supply opening in the left-right direction.

What is claimed is:

1. A container attachable to an image-forming apparatus, the container comprising:
a container body defining a storage chamber configured to store liquid therein, the container body having a liquid supply opening that is open frontward and a communication opening that is open to the storage chamber, the container body comprising:
a liquid channel extending in a front-rear direction to connect the communication opening to the liquid supply opening;
a front wall;
a rear wall opposite the front wall in the front-rear direction;
a first side wall connecting the front wall to the rear wall, the first side wall having a first outer surface and a first inner surface;
a second side wall opposite the first side wall in a left-right direction crossing the front-rear direction, the second side wall having a second outer surface and a second inner surface;
an upper wall connecting the front wall to the rear wall in the front-rear direction, the upper wall also connecting the first side wall to the second side wall in the left-right direction; and
a lower wall opposite the upper wall in an up-down direction crossing the front-rear direction and the left-right direction,
wherein at least one of the first side wall and the second side wall has a recessed portion, the recessed portion having: an outer surface that is recessed from the first outer surface or the second outer surface; and an inner surface protruding from the first inner surface or the second inner surface,
wherein at least a part of the recessed portion is positioned above the liquid supply opening in the up-down direction, and
wherein the inner surface of the recessed portion defines a part of the storage chamber.

2. The container according to claim 1,
wherein the first side wall and the second side wall have translucency capable of transmitting light therethrough to allow a level of the liquid stored in the storage chamber to be visually observed from an outside of the container body.

3. The container according to claim 1,
wherein each of the first side wall and the second side wall has the recessed portion, and
wherein the inner surface of the recessed portion of the first side wall faces the inner surface of the recessed portion of the second side wall in the left-right direction.

4. The container according to claim 1,
wherein the inner surface of the recessed portion includes a crossing surface intersecting with the first inner surface or the second inner surface to form an angle of not less than 90 degrees relative thereto.

5. The container according to claim 1,
wherein the inner surface of the recessed portion includes an upper crossing surface facing upward and intersecting with the first inner surface or the second inner surface, the upper crossing surface extending to be inclined relative to the front-rear direction.

6. The container according to claim 1,
wherein the recessed portion is positioned to overlap with a center in the front-rear direction between the front wall and the rear wall, and
wherein the recessed portion has a length in the front-rear direction that is equal to or greater than one half of a distance in the front-rear direction between the front wall and the rear wall.

7. The container according to claim 1,
wherein the recessed portion is not open to any one of the front wall, the rear wall, the upper wall, and the lower wall.

8. The container according to claim 1,
wherein the recessed portion is open to at least one of the front wall, the rear wall, the upper wall, and the lower wall.

9. The container according to claim 1,
wherein the container body has a dimension in the left-right direction that is smaller than dimensions thereof in the up-down direction and in the front-rear direction.

10. The container according to claim 1,
wherein the recessed portion is positioned above the communication opening in the up-down direction.

11. The container according to claim 1,
wherein the inner surface of the recessed portion is connected to the communication opening.

12. The container according to claim 1,
wherein the communication opening is open to the part of the storage chamber, the part being defined by the inner surface of the recessed portion in the left-right direction.

13. The container according to claim 1,
wherein the recessed portion has a sub-recessed portion formed in the outer surface of the recessed portion to be recessed therefrom.

14. The container according to claim 13,
wherein the sub-recessed portion has an inner surface defining the part of the storage chamber.

15. The container according to claim 13,
wherein the sub-recessed portion has an inner surface that does not define the part of the storage chamber.

16. The container according to claim 1,
wherein the inner surface of the recessed portion includes a crossing surface intersecting with the first inner surface or the second inner surface to define a ridge therebetween, the ridge being inclined diagonally upward as extending away from the communication opening in the front-rear direction.

17. The container according to claim 1,
wherein the liquid channel has a sloped surface that is inclined diagonally upward toward the communication opening.

18. The container according to claim 1,
wherein the communication opening is open upward in the up-down direction.

19. The container according to claim 1,
wherein the communication opening has a dimension in the left-right direction that is smaller than a dimension of the liquid supply opening in the left-right direction.

20. The container according to claim 1,
wherein the inner surface of the recessed portion has a lower end that is positioned below the communication opening in the up-down direction.
